(19) United States
(12) Patent Application Publication
(10) Pub. No.: US 2022/0016627 A1
(43) Pub. Date: Jan. 20, 2022

(54) DETECTION OF COMPONENTS

(71) Applicants: Fluidic Analytics Limilted, Cambridge, Cambridgeshire (GB); Cambridge Enterprise Limited, Cambridge, Cambridgeshire (GB)

(72) Inventors: Tuomas Pertti Jonathan Knowles, Cambridge, Cambridgeshire (GB); Kadi Liis Saar, Cambridge, Cambridgeshire (GB); Quentin Alexia Eric Peter, Cambridge, Cambridgeshire (GB); Pavan Kumar Challa, Cambridge, Cambridgeshire (GB); Thomas Mueller, Cambridge, Cambridgeshire (GB)

(73) Assignees: Fluidic Analytics Limilted, Cambridge, Cambridgeshire (GB); Cambridge Enterprise Limited, Cambridge, Cambridgeshire (GB)

(21) Appl. No.: 17/414,856

(22) PCT Filed: Dec. 20, 2019
(86) PCT No.: PCT/GB2019/053670

§ 371 Date: Jun. 16, 2021

(30) Foreign Application Priority Data
Dec. 20, 2018 (GB) 1820870.2

(51) Int. Cl. B01L 3/00

(52) U.S. Cl. CPC B01L 3/502715; B01L 3/50273; B01L 3/502746; B01L 2300/0663; B82Y 35/00; B01L 2300/0864; B01L 2300/0896; B01L 2400/0418; B01L 2300/0883

(57) ABSTRACT

A flow apparatus for detecting a component on a surface is provided. The flow apparatus, comprising an inlet for receiving a solution of the components to be detected; a detection chamber in fluid connection with and downstream from the inlet, and in fluid connection with a downstream outlet, wherein the internal surface of the detection chamber comprises a plurality of detection zones and the detection zones are configured to adhere to the component to be detected such that the component is immobilised in the detection zones; a detector for detecting components immobilised on each of the detection zones; and a director for directing the flow of the solution of the components to each of the detection zones in sequence, wherein the director is provided by flow rates.

### FIELD OF THE INVENTION

The present invention relates to the detection of components on a surface, in particular to devices and methods for detecting components on a surface.

### BACKGROUND

Single molecule detection and imaging techniques are emerging as powerful tools for the detection or visualisation of individual biological molecules on a surface or in solution. Surface-based single molecule detection preferably requires a clean surface area—such as a fresh piece of surface—for each measurement.

Single molecule detection and imaging has been achieved by labelling analytes with fluorophores and visualising the labelled molecules. Methods and devices often use ultrasensitive fluorescence detection approaches, such as total internal reflection fluorescence microscopy (TIRF), Foster resonance Energy Transfer microscopy (FRET) and fluorescence correlation spectroscopy (FCS).

Single molecule detection and imaging on a surface has also been achieved using label-free approaches (for example see Piliarik et al., Nat. Commun, and Lee, et al., Science, 360). Typically these approaches are based on scattering phenomena such as interferometric scattering microscopy (iSCAT). iSCAT has recently reached a precision of 1 kDa at a lower limit of 19 kDa.

Measurements of individual biomolecules are performed by visualising them on a surface. Due to the highly sensitive nature of single molecule measurements, the imaging process has to take place on a clean surface. This typically limits the use of current approaches to studying samples at a single instance rather than probing their evolution over time.

Moreover, the requirement for a clean surface similarly prevents their use in applications that involve studying mixtures of biomolecules and requires pre-fractionation or other preparative steps to be performed before the optical analysis.

One approach to avoid the need for a fresh surface is to perform a background subtraction step (Young et al., Science 360, 2018, pp 423-427).

Visualisation of highly heterogeneous samples is challenging with current biochemical and biophysical techniques. Additionally, the lack of single platform that allows robust separation (or any other upstream processing procedure) together with single molecule detection means that such visualisation is difficult.

The present inventors have now established alternative fluidic devices and methods for the detection of components on a surface. The devices and methods of the present invention aim to solve one or more of the problems associated with prior art devices and methods.

### SUMMARY OF THE INVENTION

The present invention provides a flow apparatus for detecting a component on a surface having multiple detection zones. A solution of the components to be detected is directed to one of the multiple detection zones and is immobilised at the detection zone. The flow apparatus also has a detector for detecting a component immobilised at the detection zone. The flow apparatus of the present invention allow for multiple components to be analysed rapidly in sequence.

The present invention provides a flow apparatus for detecting a component on a surface, comprising an inlet for receiving a solution of the components to be detected, a detection module having a plurality of detection channels arranged in parallel and a detector for detecting components in the detection zone of each of the plurality of detection channels. The detection module is in fluid connection with and downstream from the inlet and in fluid connection with a downstream outlet. A portion of the internal surface of each detection channel is a detection zone and the detection zone is configured to adhere to the component to be detected such that the component is immobilised on the detection zone.

Furthermore, according to the present invention, there is provided a flow apparatus for detecting a component on a surface, comprising:
an inlet for receiving a solution of the components to be detected;
a detection chamber in fluid connection with and downstream from the inlet, and in fluid connection with a downstream outlet,
wherein the internal surface of the detection chamber comprises a plurality of detection zones and the detection zones are configured to adhere to the component to be detected such that the component is immobilised in the detection zones;
a detector for detecting components immobilised on each of the detection zones; and
a director for directing the flow of the solution of the components to each of the detection zones in sequence, wherein the director is provided by flow rates.

Moreover, according to the present invention there is provided a flow apparatus for detecting a component on a surface, comprising an inlet for receiving a solution of the components to be detected, a detection chamber wherein the internal surface of the detection chamber comprises a plurality of detection zones and the detection zones are configured to adhere to the component to be detected such that the component is immobilised on the detection zones, a detector for detecting components immobilised on each of the detection zones, and a director for directing the flow of the solution of the components to each of the detection zones in sequence. The detection chamber is in fluid connection with and downstream from the inlet and in fluid connection with a downstream outlet.

The present invention provides a platform for interfacing single molecule measurements with fluidic devices, such as microfluidic or nanofluidic devices. Specifically, the flow apparatus of the present invention provides a fluidic device, preferably a microfluidic device, with a plurality of detection surfaces. In addition, the process of directing the fluid flow on the surface is an active process because it utilises a director such as a smart fluid control director or a time-limited director. The time-limited director may be configured to direct the flow of the solution to each detection zone sequentially in a time ordered sequence. In some embodiments, the director directs the flow of the solution to each detection zone sequentially for an equal time.

In some embodiments, the director may be a smart fluid control director which is configured to use information from the detector to close a feedback loop such that, when a significant fraction of the surface is covered by one or more components, the director redirects the flow of the solution to the next detection area so that the majority of each component adheres to a separate detection zone. Alternatively, the redirection can happen when a given component stops coming through the inlet channel in order to have a clean surface whenever a new component arrives, or when a second component is detected by the detector.

In this way, the flow apparatus of the present invention provides the possibility of performing single molecule measurements in a multiplexed manner and across multiple domains. For example, the flow apparatus allows detection at different times by utilising different detection surfaces over time, thereby enabling the temporal evolution of samples to be studied, e.g. the sample may be treated under different external conditions and the effects of this can be determined in the single device of the invention.

The fluidic device of the invention may be combined with other microfluidic devices to allow probing of samples either in a temporally or spatially resolved form.

These and other aspects and embodiments of the invention are described in further details below.

### DESCRIPTION OF THE FIGURES

FIG. 1 shows an example schematic of an embodiment of the flow apparatus of the second aspect of the invention having a detection chamber including a flow directing module.

FIG. 2 shows images of the detection of (a) individual 50 nm radius fluorescent nanoparticles and of (b) individual green fluorescent protein molecules using total internal reflection fluorescence microscopy (TIRF).

FIG. 3 shows images of the detection of (a) 50 nm radius nanoparticles and of (b) antibody molecules using interferometric scattering microscopy (iSCAT).

FIG. 4 shows a schematic of an embodiment of a flow apparatus according to the first aspect of the invention including a flow directing module.

FIG. 5 shows two apparatus schematics of an embodiment of a flow apparatus according to the first aspect of the invention for use with electroosmotic flow having a plurality of outlets. FIG. 5(a) shows an apparatus for use with electroosmotic flow having an auxiliary carrier medium.

FIG. 5(b) shows an apparatus for use with electroosmotic flow without an auxiliary carrier medium. Each of these apparatus' could be adapted for use with the flow apparatus according to the invention.

FIG. 5(c) shows an alternative embodiment of an apparatus for use with electroosmotic flow without an auxiliary carrier medium.

FIG. 6 shows images of the experimental performance of the directing module shown in FIG. 4.

FIG. 7 shows schematics for a number of different flow apparatus' of an embodiment of a flow apparatus according to the first aspect of the invention the invention. FIG. 7(a) shows a slow apparatus with a flow directing module; FIG. 7(b) shows a flow apparatus with a flow directing module as in FIG. 7(a) also having a treatment device; FIG. 7(c) shows a flow apparatus with a separation unit having a field perpendicular to the direction of the flow; and FIG. 7(d) shows a flow apparatus with a separation unit having a field in the direction of the flow. Each of these apparatus' could be adapted for use with the flow apparatus according to the second aspect of the invention.

### DETAILED DESCRIPTION OF THE INVENTION

The apparatus of the invention provides an apparatus for the analysis, such as characterisation or quantification, of a component, including a component in a multicomponent mixture, in a solution by immobilizing the component on a surface.

Flow Apparatus

The present invention provides a flow apparatus. The flow apparatus may be used in the methods of invention discussed below.

The flow apparatus of the present invention may be an integrated device, such as a monolithic device, having an integrated network of channels.

The flow apparatus makes use of small fluidic channels, particularly microfluidic channels, and therefore very small sample volumes may be analysed. Thus, components provided in solutions of less than a microliter volume may be analysed by the methods described herein. Furthermore, fluid flow techniques can also be used to analyse very dilute samples, by appropriate increases in the measurement times.

The flow apparatus may be provided with a detector for detecting nanoparticles, protein molecules, colloids, complexes such as protein complexes, oligomers such as alpha-synuclein oligomers, antibodies, nucleotides, biomolecules or biomolecular complexes.

The flow apparatus of the present invention may incorporate the flow device of the inventors' earlier work, as described in PCT/GB2013/052757 (published as WO/2014/064438), the contents of which are hereby incorporated by reference in their entirety.

The flow apparatus of the invention allows fluids to flow through an inlet, a detection module including a detection zone and an outlet. The establishment of flow through a fluidic device, such as a microfluidic device, is well known to those of skill in the art. For example, the fluid flows may be provided by syringe pumps that are the reservoirs for the various fluid channels. Alternatively, fluid flow may be established by pneumatic or gravity feed of fluids into the device. In another alternative, fluid flow may be established by drawing liquids through the device from the fluid exits in the device, for example using a syringe pump. In a further alternative, the fluid flow may be driven electrokinetically with the application of electric potential.

A device of the invention may incorporate or use one or more of these different flow techniques.

The devices of the invention may be prepared in part using standard photolithographic techniques, such as described herein. The devices of the invention may also be prepared in part using standard injection moulding or embossing techniques.

Detection Module

The flow apparatus of the present invention has a detection module. The detection module has multiple detection zones. In this way, multiple detection events can be carried out using a single detection module.

Multiple Detection Channels

In one aspect, the detection module comprises a plurality of detection channels in parallel.

The plurality of detection channels are in fluid connection with and downstream from the inlet.

The detection channels are described as parallel. The term parallel used in this context means that each detection channel is connected to common points at each end of each detection channel (e.g. parallel is used in this context in the same way as parallel is used to describe certain electrical circuits and does not require each channel to be side by side, or to maintain the same distance continuously along their length).

In some embodiments the detection module has at least two (2) detection channels, for example, at least 5 detection channels, at least 10 detection channels or at least 20 detection channels.

In some embodiments the detection module has at most 1000 detection channels, for example, at most 500 detection channels, at most 100 detection channels or at most 30 detection channels.

The detection module may have a number of detection channels defined by any combination of the above ranges. For example the detection module may have from 10 to 100 detection channels.

The term channel refers to structures having at least a bed (e.g. a base or a bottom) and two side walls on opposing sides of the bed, along the length of the channel. The term channel thus encompasses channels that are not fully enclosed along their length (i.e. have no top wall) and channels that are enclosed along their length (i.e. have a top wall).

In some embodiments each detection channel has a height of 500 μm or less, for example 300 μm or less, 100 μm or less, 50 μm or less or 10 μm or less.

In some embodiments each detection channel has a width of 500 μm or less, for example 300 μm or less, 100 μm or less, 50 μm or less or 10 μm or less.

The detection channel may have height and width as defined by any combination of the above ranges. For example the detection channel may have a height of 100 μm or less and a width of 500 μm or a height of 10 μm or less and a width of 500 μm or less.

The detection channels may be microchannels.

The term height in this context refers to the height as measured from the bed of the detection channel. The term width in this context refers to the width as measured from a side wall to an opposing side wall of the channel.

In this way, the convective movement of the components may be limited to movement in the direction of flow in the detecting channels. It is proposed that limiting the lateral movement of the components can promote adhesion of the component in the detection zone.

In some embodiments each detection channel has a length of 10,000 μm or less, for example 5,000 μm or less, 1,000 μm or less, or 600 μm or less.

In some embodiments each detection channel has a length of 5 μm or more, for example 10 μm or more, 50 μm or more, 100 μm or more or 500 μm or more.

The detection channel may have a length as defined by any combination of the above ranges. For example the detection channel may have a length of 100 μm or more and 1,000 μm or less.

The term length in this context refers to the dimension measured in the direction of flow through the device.

A portion of the internal surface of each detection channel is the detection zone which is configured to adhere to the component to be detected such that the component is immobilised on the detection zone. The internal surface refers to the surface which contacts the solution within the device.

The component is adhered to the detection zone for a period of time suitable to allow detection to occur. The component may be adhered for longer time periods. For example, the component may be adhered to the surface for at least 0.1 second, at least 1 second, at least 10 seconds, at least 60 seconds, at least 300 seconds or at least 600 seconds.

The detection zone may be on the bed of the channel.

In some embodiments the detection zone is optically transparent. The detection zone may have a refractive index of at least 1.0, preferably at least 1.5 and more preferably at least 1.7. The detection zone may have a refractive index of at most 3, preferably at most 2.5 and more preferably at most 2.0. The detection zone may have a refractive index within the range provided by of any of the above values, for example, the detection zone may have a refractive index of from 1.0 to 2.5, preferably 1.5 to 2.0.

The detection zone may transmit at least 25% of light at the measurement wavelength, for example the detection zone may transmit at least 50%, at least 75% or at least 90% of light at the measurement wavelength. Preferably the detection zone may transmit at least 99.9% of light at the measurement wavelength.

The detection zone may be any suitable optically transparent material such as a glass or quartz. Preferably, the detection zone is a glass, such as a borosilicate glass. The detection zone may be provided by a glass coverslip. The glass coverslip may be incorporated during the production of the flow apparatus. The glass coverslip may form the bed of the channel.

A component that is immobilised in the detection zone is not removed from the surface under normal operating flow rates, such as the flow rates described herein. Detection occurs when a component is immobilized on the detection zone. For example, detection may occur when a component is within evanescent penetration distance for TIRF experiment or on the surface for iSCAT. For example, detection may occur when a component is within 30 to 300 nm, preferably 60 to 100 nm, distance from the detection zone and does not move in the direction of flow (i.e. the component is immobilised). That is, the evanescent penetration distance may be from 60 to 100 nm.

The detection zone may be wider or narrower than the rest of the detection channel (rather than the same width). In this way, the detection zone can be precisely located by the detector.

In some embodiments each of the detection zones may have a width of at least 1 μm, for example at least 5 μm or at least 10 μm, preferably at least 15 μm and most preferably at least 20 μm.

In some embodiments each of the detection zones may have a width of at most 1,000 μm, for example at most 200 μm, at most 150 μm, at most 100 μm or at most 50 μm.

Each of the detection zones may have a width within the range provided by the combination of any of the above limits. For example, each of the detection zones may have a width of from 5 μm to 100 μm.

The term width in this context refers to the width as measured from a side wall to an opposing side wall of the channel.

In some embodiments each detection zone has a length of 10,000 μm or less, for example 1,000 μm or less, 500 μm or less, 200 μm or less, 150 μm or less, 100 μm or less, or 50 μm or less.

In some embodiments each detection zone has a length of 1 μm or more, 5 μm or more, for example 10 μm or more, 15 μm or more, 20 μm or more, 50 μm or more, 100 μm or more or 500 μm or more.

The detection zone may have a length as defined by any combination of the above ranges. For example the detection zone may have a length of 20 μm or more and 100 μm or less.

In some embodiments each detection zone has an area of 1.0 mm² or less, for example 0.1 mm² or less, 10,000 μm² or less, 2,500 μm²or less or 1,000 μm² or less.

In some embodiments each detection zone has an area of 1 μm² or more, for example 100 μm² or more, 400 μm² or more, 1,000 μm²or more or 10,000 μm² or more.

The detection zones may have an area as defined by any combination of the above ranges. For example, each detection zone may have an area of 400 μm² or more and 10,000 μm² or less.

Each detection zone is in fluid connection with a downstream outlet.

The detection zone is configured to adhere to the component to be detected such that the component to be detected is immobilised in the detection zone. The detection zone may be coated with a material that adheres to the component to be detected, may be treated (e.g. chemically or physically) to adhere to the component to be detected or may comprise a material that adheres to the component to be detected.

The detection zone may be configured to adhere to the component to be detected by ionic interactions, covalent bonding or non-covalent interactions. The interactions may be non-specific interactions such as electrostatic interactions, hydrophilic interactions, van der Waals interactions or hydrophobic interactions. The interactions may be specific interactions such as antibody-antigen interactions

In some cases, different detection zones may be configured to adhere to different components. In this way, the detection of multiple components in a mixture can be carried out using a single device.

In some embodiments, the detection zone may be treated to adhere to specific targets of interest. For example, the detection zone may be treated with an affinity reagent for binding the component of interest, such as antibodies or aptamers that target the component of interest.

In one embodiment, the detection zone may be hydrophilic or hydrophobic. The present inventors have found that the use of hydrophilic channel surfaces promote adhesion of hydrophilic components. Similarly, hydrophobic channels may be used to promote adhesion of hydrophobic components, such as hydrophobic proteins.

Hydrophilic channels may be prepared using techniques familiar to those in the art. For example, where the channels in a device are prepared from PDMS, the material may be plasma treated to render the surfaces hydrophilic. Here, the plasma treatment generates hydrophilic silanol groups on the surface of the channels. Such techniques described by Tan et al. (Biomicrofluidics 4, 032204 (2010)). Hydrophilic surfaces can also be produced by chemical treatment of the channel, for example by treatment with polyvinyl alcohol.

Hydrophobic surfaces may be produced by chemical treatment of the channel, for example by treatment with a hydrophobic silicone polymer (e.g. Rain-X) or a hydrophobic fluorinated compound such as a fluoroalkylsilane (e.g. Aquapel).

The surface of the channel except the detection zone may be treated to prevent adhesion of the component to be detected.

The internal surface of the detection channels except the detection zone may be adapted to prevent components from adhering to these surfaces. Thus, in one embodiment, the internal surfaces of the detection channels except the detection zone limit or prevent absorption of a component onto the surface.

In one embodiment, the internal surface of the detection channels except the detection zone may be hydrophilic or hydrophobic. The present inventors have found that the use of hydrophilic channel surfaces prevent the absorption of hydrophobic components, such as hydrophobic proteins. Similarly, hydrophobic channels may be used to prevent the absorption of hydrophilic components.

For example, if a hydrophobic protein is the component to be detected, the detection zone may be adapted to adhere to the hydrophobic protein by having a hydrophobic surface and the surface of the detection channel except the detection zone may be hydrophilic to prevent adherence of the hydrophobic protein.

Detection Chamber

In another aspect, the detection module comprises a detection chamber. The detection chamber is in fluid connection with and downstream from the inlet. In this aspect, a director is also present in the apparatus to direct fluid flow.

The internal surface of the detection chamber comprises a plurality of detection zones which are configured to adhere to the component to be detected such that the component is immobilised on the detection zones. The internal surface refers to the surface which contacts the solution within the device. The plurality of detection zones may be provided by discrete areas on the internal surface or may be provided by one area on the internal service with a plurality of zones on which detection can take place.

In this aspect, the director directs the flow of the solution containing the component to be analysed to each detection zone in sequence.

In some embodiments the detection chamber has at least 10 detection zones, for example, at least 30 detection zones.

The detection zones may be spaced apart (e.g. may be discrete zones) or may be contiguous to form one large area. When the detection zones are contiguous the director directs flow onto individual zones within the area to immobilising the component to be detected in that zone for detection. The detection zones may be arranged across the flow direction.

In some embodiments the detection chamber may have a width of at least 100 μm, preferably at least 200 μm, for example at least 600 μm and most preferably at least 1000 μm.

In some embodiments the detection chamber may have a width of at most 1.0 cm, preferably at most 0.5 cm and most preferably at least 5,000 μm.

The detection chamber may have a width within the range provided by the combination of any of the above limits. For example, the detection chamber has a width of from 100 μm to 1.0 cm.

In some embodiments each of the plurality of detection zones may have a width of at least 1 μm, for example at least 10 μm, preferably at least 15 μm and most preferably at least 20 μm.

In some embodiments each of the plurality of detection zones may have a width of at most 200 μm, preferably at most 150 μm and most preferably at most 50 μm.

Each of the plurality of detection zones may have a width within the range provided by the combination of any of the above limits. For example, each of the plurality of detection zones may have a width of from 20 μm to 150 μm.

The term width in this context refers to the width as measured in the direction from a side wall of the detection chamber to an opposing side wall of the detection chamber.

In some embodiments each detection zone has a length of 10,000 μm or less, for example 1,000 μm or less, 500 μm or less, 200 μm or less, 150 μm or less, 100 μm or less, or 50 μm or less.

In some embodiments each detection zone has a length of 1 μm or more, 5 μm or more, for example 10 μm or more, 15 μm or more, 20 μm or more, 50 μm or more, 100 μm or more or 500 μm or more.

The detection zone may have a length as defined by any combination of the above ranges. For example the detection zone may have a length of 20 μm or more and 100 μm or less.

In some embodiments each detection zone has an area of 1.0 mm² or less, for example 0.1 mm² or less, 10,000 μm² or less, 2,500 μm² or less or 1,000 μm² or less.

In some embodiments each detection zone has an area of 1 μm² or more, for example 100 μm² or more, 400 μm² or more, 1,000 μm²or more or 10,000 μm² or more.

The detection zones may have an area as defined by any combination of the above ranges. For example, each detection zone may have an area of 400 μm² or more and 10,000 μm² or less.

In some embodiments the detection zones are on the bed of the chamber.

In some embodiments the detection zones are transparent. The detection zones may have a refractive index of at least 1.0, preferably at least 1.5 and more preferably at least 1.7. The detection zones may have a refractive index of at most 3, preferably at most 2.5 and more preferably at most 2.0. The detection zones may have a refractive index within the range provided by of any of the above values, for example, the detections zone may have a refractive index of from 1.0 to 2.5, preferably 1.5 to 2.0.

The detection zones may be any suitable optically transparent material such as a glass or quartz. Preferably, the detection zones are a glass, such as a borosilicate glass. The detection zones may be provided by a glass coverslip. The glass coverslip may be incorporated during the production of the flow apparatus. The glass coverslip may form the bed of the chamber.

Once components are immobilised in one of the detection zones, they are not carried away by normal operating flow rates. Detection occurs when a component is immobilized on one of the detection zones. For example, detection may occur when a component is within evanescent penetration distance for TIRF experiment or on the surface for iSCAT. For example, detection may occur when a component is within 30 to 300 nm, preferably 60 to 100 nm, distance from one of the detection zones and does not move. That is, the evanescent penetration distance may be from 60 to 100 nm.

The detection zone is configured to adhere to the component to be detected such that the component to be detected is immobilised in the detection zone. The detection zone may be coated with a material that adheres to the component to be detected, may be treated (e.g. chemically or physically) to adhere to the component to be detected or may comprise a material that adheres to the component to be detected.

The detection zone may be configured to adhere to the component to be detected by ionic interactions, covalent bonding or non-covalent interactions. The interactions may be non-specific interactions such as electrostatic interactions, hydrophilic interactions, van der Waals interactions or hydrophobic interactions. The interactions may be specific interactions such as antibody-antigen interactions

In some cases, different detection zones may be configured to adhere to different components. In this way, the detection of multiple components in a mixture can be carried out using a single device.

In some embodiments, the detection zone may be treated to adhere to specific targets of interest. For example, the detection zone may be treated with an affinity reagent for binding the component of interest, such as antibodies or aptamers that target the component of interest.

In one embodiment, the detection zone may be hydrophilic or hydrophobic. The present inventors have found that the use of hydrophilic channel surfaces promote adhesion of hydrophilic components. Similarly, hydrophobic channels may be used to promote adhesion of hydrophobic components, such as hydrophobic proteins.

Hydrophilic channels may be prepared using techniques familiar to those in the art. For example, where the channels in a device are prepared from PDMS, the material may be plasma treated to render the surfaces hydrophilic. Here, the plasma treatment generates hydrophilic silanol groups on the surface of the channels. Such techniques described by Tan et al. (Biomicrofluidics 4, 032204 (2010)). Hydrophilic surfaces can also be produced by chemical treatment of the channel, for example by treatment with polyvinyl alcohol.

Hydrophobic surfaces may be produced by chemical treatment of the channel, for example by treatment with a hydrophobic silicone polymer (e.g. Rain-X) or a hydrophobic fluorinated compound such as a fluoroalkylsilane (e.g. Aquapel).

The surface of the channel except the detection zone may be treated to prevent adhesion of the component to be detected.

The internal surface of the detection channels except the detection zone may be adapted to prevent components from adhering to these surfaces. Thus, in one embodiment, the internal surfaces of the detection channels except the detection zone limit or prevent absorption of a component onto the surface.

In one embodiment, the internal surface of the detection channels except the detection zone may be hydrophilic or hydrophobic. The present inventors have found that the use of hydrophilic channel surfaces prevent the absorption of hydrophobic components, such as hydrophobic proteins. Similarly, hydrophobic channels may be used to prevent the absorption of hydrophilic components.

For example, if a hydrophobic protein is the component to be detected, the detection zone may be adapted to adhere to the hydrophobic protein by having a hydrophobic surface and the surface of the detection channel except the detection zone may be hydrophilic to prevent adherence of the hydrophobic protein.

Detector

The flow apparatus of the present invention comprises a detector. The detector is a device that is capable of detecting a component on a surface. The detector may be any such detector, in particular the detector may be a detector that benefits from the use of a fresh surface for detection of components.

The detector is located to enable detection of a component immobilised on the surface of each detection channel at the detection zone or at each of the plurality of detection zones of the detection chamber.

In some embodiments, the detector is an optical detector. The optical detector may detect components by interferometric scattering microscopy, internal reflection fluorescence microscopy, surface-enhanced Raman spectroscopy or surface plasmon resonance.

Some detectors can be used for extracting additional information. For example, information about the concentration of the sample can be obtained when the detector detects components by complementary metal-oxide-semiconductor (CMOS) camera, photodiodes, avalanche photodiodes (APDs) or photomultiplier tubes. The molecular weight can be determined when the detector detects components by interferometric scattering microscopy.

Director

When the flow apparatus comprises multiple detection channels, the flow apparatus of the present invention may comprise a director for directing flow from the inlet to individual detection channels of the plurality of detection channels.

In this way, the director is used to direct a sample of the solution containing the component to a specific part of the detection zone in the detection chamber. This allows the sample to be analysed at different time points or under different conditions.

When the flow apparatus comprises a detection chamber, the flow apparatus of the present invention comprises a director for directing flow from the inlet to individual detection zones in sequence.

In this way, the director can be used to direct a sample of the solution containing the component to different detection zones and allow analysis of the sample. This allows multiple analyses of the sample to be carried out in a single device and allows the sample to be analysed at different time points or under different conditions.

In some embodiments, the director may be a displacement controlled director, a pressure controlled director, a gravity controlled director, an electroosmotic director or a flow director. The electroosmotic director directs the sample flow using an electroosmotic force for example, the electroosmotic controlled director may be adapted to provide electric potential. For the avoidance of doubt, displacement, pressure and EOF controlled directors are all examples of flow directors.

In some cases, it is advantageous to provide an electro-osmotic director, a pressure driven director and/or a displacement controlled director due to the simplicity of implementing such director(s) into the complete flow apparatus. In some embodiments, the electro-osmotic director may also be advantageous because it can be used to constantly provide a steady flow rate upon the application of an electric potential. This can reduce or minimise any impact on the fluid flow distributions that have been created through upstream processes.

Preferably the director is flow controlled using a flow director. For example, the flow director may comprise two directing inlets. The two directing inlets are positioned on opposite sides of the inlet and each of the two directing inlets is configured to provide variable flow rates. In use the flow rates of the fluid from the two directing inlets (QcL and QcR) can be adjusted to direct the sample flow (Qs) to a specific detection channel. The ratio of the directing flow rates QcL/QcR can be increased or decreased to move the sample flow from one detection area to its neighbouring one.

In some cases individual detection zones may be targeted by appropriately selecting the ratio Qs/(QcL+QcR). In some cases, several detection areas may be targeted at the same time by increasing Qs/(QcL+QcR). In some cases, the sample flow may be selected to be narrower than the width of a detection area to reduce the precision required on QcL and QcR by decreasing the ratio Qs/(QcL+QcR).

The flow rates of the individual flows may be controlled by appropriate use of, for example, syringe pumps.

Typical flow rate suitable for use in the apparatus of the invention, such as in the detection module, are at least 5, 10, 50, 100, 200 or 500 μL h⁻¹. The flow rate is at most 2,000, at most 5,000 or at most 10,000 μL h⁻¹. The flow rate may be in a range selected from the upper and lower values given above. For example, the flow rate may be in the range 200 to 2,000 μL h⁻¹.

The term opposite used in this context means that the directing flow inlets are positioned so that the inlet is substantially between the directing flow inlets.

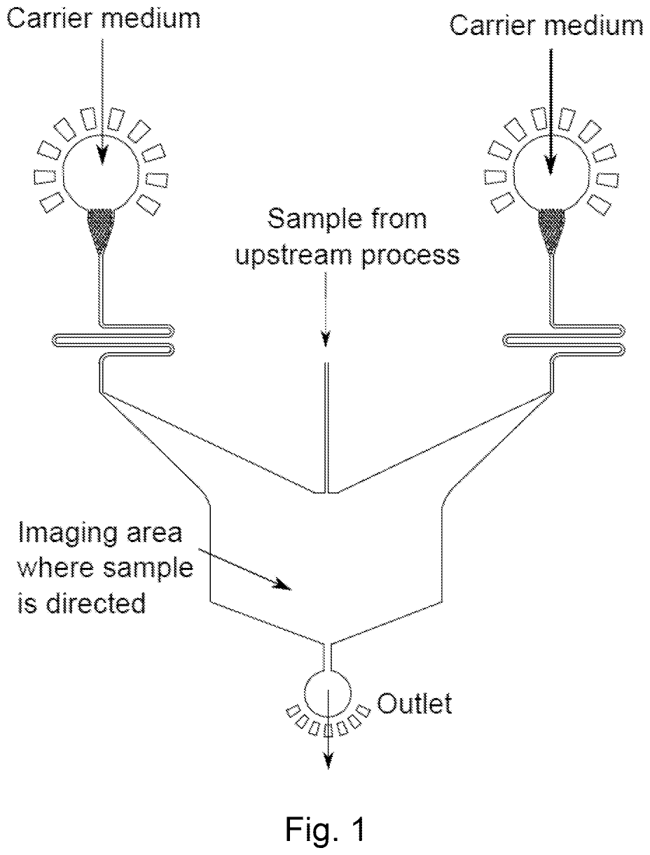

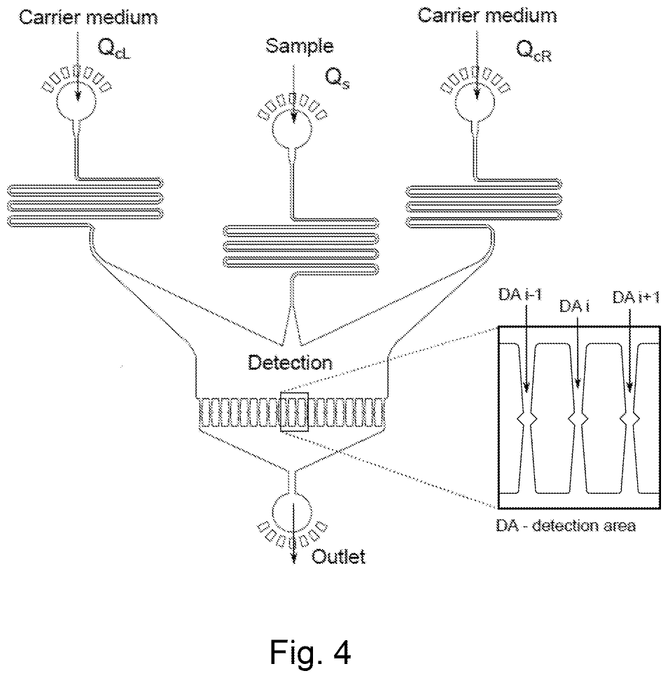

FIG. 4 shows an example schematic of a flow apparatus of the invention having multiple detection channels including a flow directing module. FIG. 1 shows an example schematic of a flow apparatus of the invention having a detection chamber including a flow directing module. In both cases, the sample enters the detection module via the central inlet. The carrier medium inlets are on opposite sides of the central inlet. The carrier medium flow rates can be adjusted to direct the sample flow to one of the detection channels in FIG. 4 or one of the plurality of detection zones in FIG. 1.

In some embodiments the flow is driven electroosmotically. In some embodiments of electroosmotic flow apparatus, multiple outlets are provided corresponding to each detection zone. In some such cases, each outlet may have a separate electrode or one electrode may be operable at each outlet separately (i.e. one electrode connected to all outlets controlled by closing a switch to apply the electrode at the outlet for an individual detection channel).

In these cases, the director can be provided by operating the electrode used to drive the flow at one of the plurality of outlets. In this way, the flow is selectively driven towards the outlet via the corresponding detection area. This is an example of an electroosmotic director.

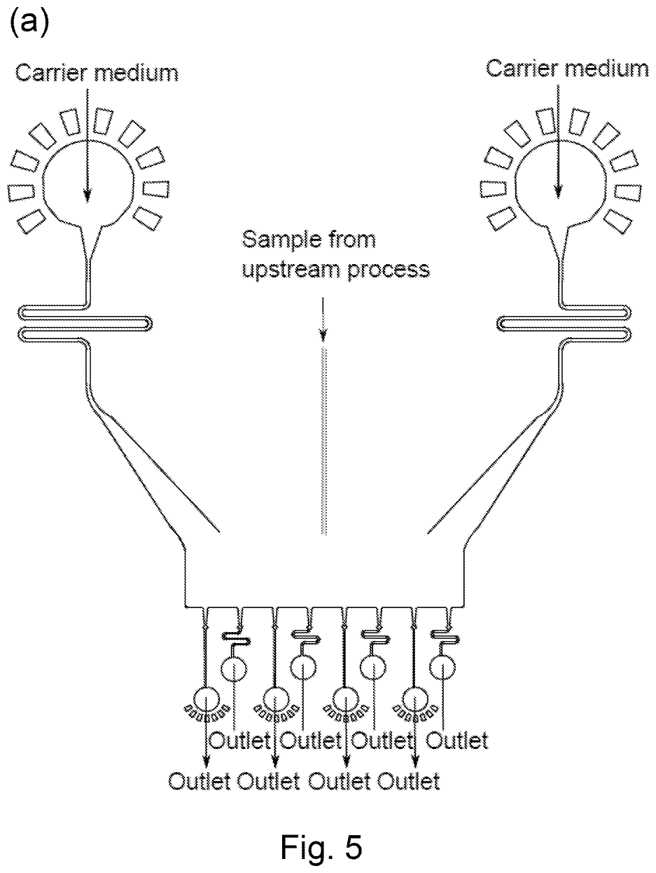

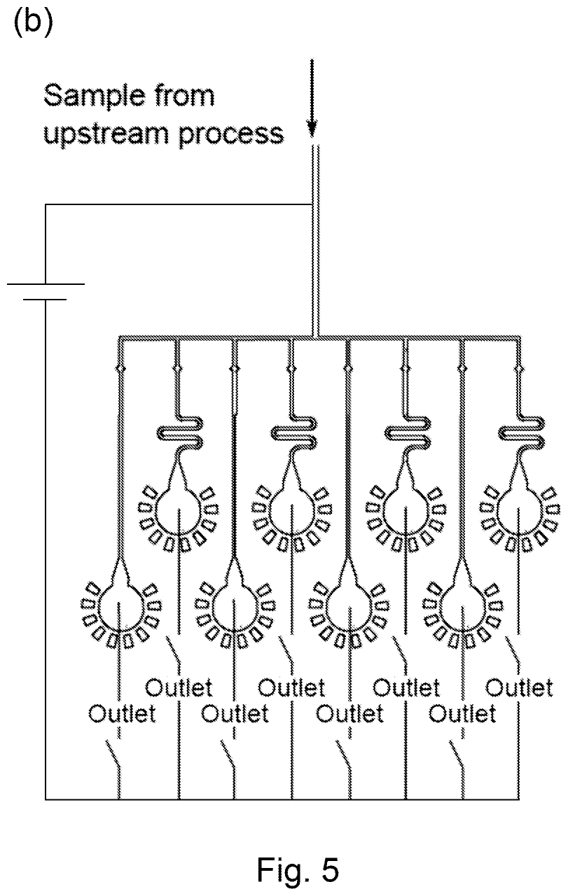

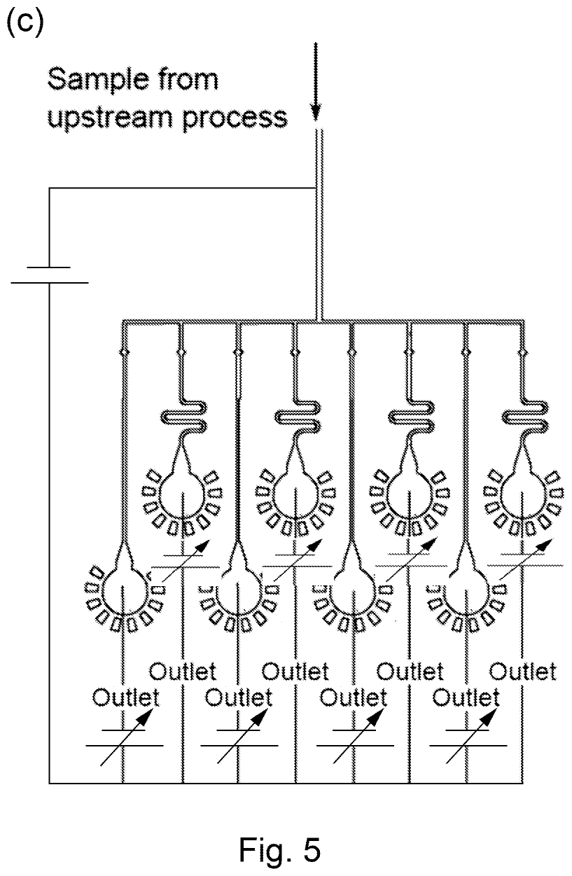

FIG. 5 shows two apparatus schematics of an embodiment of a flow apparatus according to the first aspect of the invention for use with electroosmotic flow having a plurality of outlets. FIG. 5(a) shows an apparatus for use with electroosmotic flow having an auxiliary carrier medium.

FIG. 5(b) shows an apparatus for use with electroosmotic flow without an auxiliary carrier medium. In both cases, the electroosmotic flow can be driven by placing the electrode at one of the outlets. The sample enters the apparatus from the upstream process as shown and is driven towards the particular outlet. The flow must pass the corresponding detection zone as it is driven towards the particular outlet. This allows the component to be detected to be immobilised at the detection zone and detected. Each of these apparatus' could be adapted for use with the flow apparatus according to the second aspect of the invention. In some embodiments, the electro-osmotic flow can be directed by adjusting the potential difference (voltage) between the inlet and each of the outlets. If the potential difference between the inlet and any given outlet is zero, there will be no electroosmotic flow into that outlet. If, however, the potential difference is non-zero, there will be electroosmotic flow according to the surface potential of the material used. This implementation is particularly useful if the components are driven through the upstream section of the apparatus by means of an applied electric field, which leads to electrophoretic separation in addition to the electro-osmotic flow. The polarity can be chosen depending on the surface potential in order to obtain the desired electroosmotic flow rate.

Each detection area may be separately switchable as shown in FIG. 5(b) in order to direct the flow to each detection area of the surface.

The apparatus as shown in FIG. 5(c) may provide better fluid flow control. One or more of the detection area may comprise a tuneable voltage source as shown in FIG. 5(c) in order to direct the flow to each detection area of the surface.

When connecting the director in series with an upstream treatment unit that enables adjusting the external conditions (including but not limited to ionic strength, pH), the sample can be probed under a range of environmental conditions.

Treatment Device

The flow apparatus of the present invention may further comprise a treatment device in fluid connection with and upstream from the inlet.

The treatment device may allow treatment of the solution containing the component, for example by contacting the solution with a reagent flow. The treatment device may thus comprise a treatment inlet upstream from the inlet and in fluid connection with a reagent reservoir. The reagent reservoir may provide a flow of reagent from the reservoir through the treatment inlet to contact the solution of components.

The reagent flow may contain a reagent capable of adjusting the pH and/or salt content of the solution. For example, in the case of adjusting pH, the reagent flow may be provided by two inlet streams, one containing an acid and the other one containing the conjugate base of the acid. The flow rate of each of the two inlet streams can be adjusted to adjust the amount of acid and conjugate base in the reagent flow and adjust the pH.

In some embodiments, the treatment device may be a separation device. The separation device may be a continuous separation device or a batch separation device.

The continuous separation device may be a diffusion separation device or an electrophoresis separation device. The batch separation device may be a capillary electrophoresis device. The capillary separation device may be in fluid connection with the inlet.

The separation device may be a diffusion separation device. The diffusion separation device may comprise a separation channel for receiving first and second flows of fluid. The separation channel is in fluid communication with and upstream from the inlet. The diffusion separation device permits lateral movement of components between first and second flows.

The diffusion separation device comprises a channel with suitable dimensions allowing for the generation and maintenance of a laminar flow of two (or three) streams within. The laminar flow of two streams means that the flows are side by side and are stable. Thus, there are typically no regions where the fluids recirculate, and the turbulence is minimal. Typically such conditions are provided by small channels, such as microchannels.

Devices for use in the diffusion of a component across fluid flows, such as for use in dispersive measurements, are well known in the art, and are described, for example, by Kamholz et al. (Biophysical Journal 80(4):1967-1972, 2001).

In some cases the diffusion separation device is adapted to divert a part of the first fluid flow, a part of the second fluid flow, or parts of the first fluid flow and the second fluid flow, from the separation channel into the inlet.

In some embodiments, the separation device is a field separation device. The field separation device comprises a channel for fluid containing the component to flow. The field separation device is adapted to apply a field, to the flow of fluid containing the component. The field may be an electric field or a magnetic field.

Devices for use in the electrophoresis of a component across fluid flows are well known in the art, and are described, for example, by Herling et al. (Applied Physics Letters 102, 184102-4 (2013)). Thus, the separation channel may be provided with electrodes alongside the channel length for deflecting (distributing) charged components across the channel. This is distinguishable from the devices described by the Ramsey group, where electrodes are placed at the channel ends, in order to distribute components along the channel length.

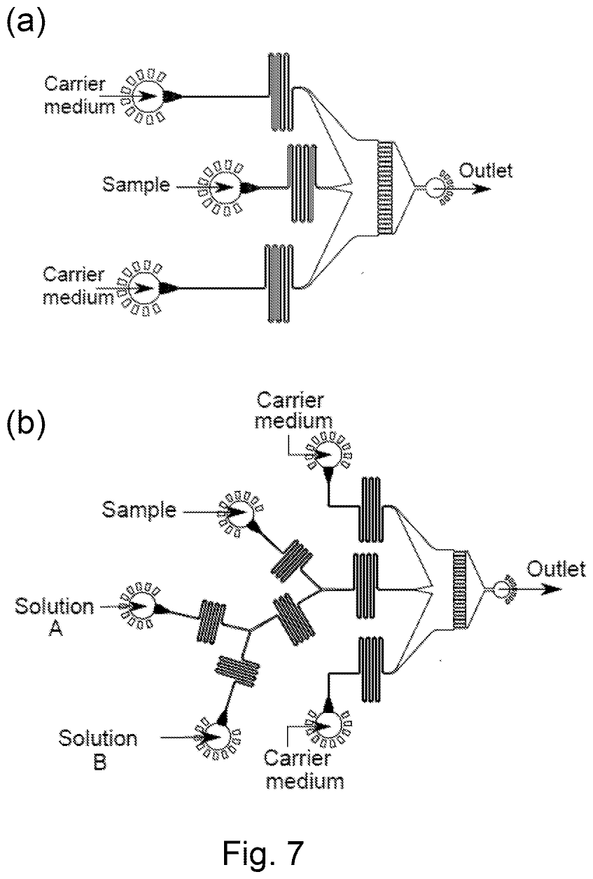

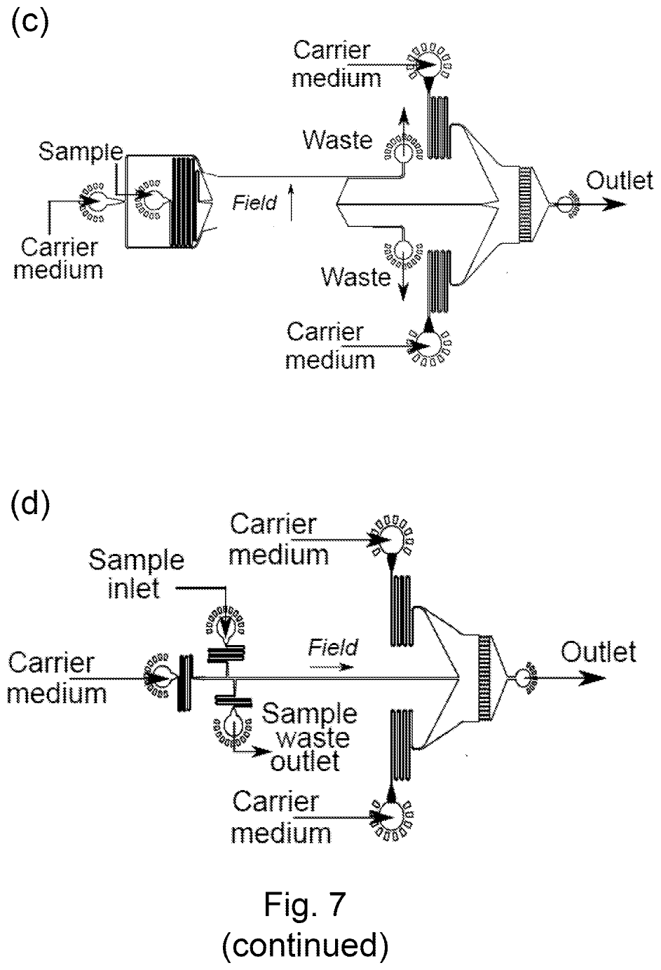

FIG. 7(c) shows an example of a flow apparatus with a separation unit having a field perpendicular to the direction of the flow. FIG. 7(d) shows an example of a flow apparatus with a separation unit having a field in the direction of the flow. Each of these apparatus' could be adapted for use with the flow apparatus according to the second aspect of the invention.

Methods

The present invention also provides methods for detecting a component on a surface using the flow apparatus of the invention. The method of the invention comprises providing a solution of the component to the inlet of the flow apparatus, establishing a flow of the solution containing the component through the inlet to the detection module or detection chamber such that the component is immobilised in the detection zone for detection by the detector and detecting the component using the detector.

The flow apparatus for use in the methods of the invention may have any of the features discussed above.

In some embodiments, the flow apparatus contains a director such that the flow of the solution containing the component is directed using director to one of the plurality of detection channels. The director may be controlled to direct the flow to different channels of the plurality of channels sequentially. The director for use in the method of the invention are as discussed above.

In a typical method the flow rate in the flow apparatus, such as in the detection module, is at least 5, 10, 50, 100, 200 or 500 μL h⁻¹. The flow rate is at most 2,000, at most 5,000 or at most 10,000 μL h⁻¹. In one embodiment, the flow rate may be in a range selected from the upper and lower values given above. For example, the flow rate may be in the range 200 to 2,000 μL h⁻¹.

In some embodiments, the flow apparatus contains a treatment device.

In some cases the treatment device is configured to treat the solution containing the component with a reagent flow. For example, the flow of the solution containing the component is contacted with a reagent solution to treat the component. In some cases, the reagent solution may be a pH or salt adjustment reagent solution. The reagent solutions for use in the method of the invention are as discussed above.

Exemplary Methods and Devices of the Invention

The present invention provides methods for analysing components in a fluid flow, preferably using the microfluidic apparatus described herein. Set out below, with reference to the accompanying figures, is a description of various embodiments of the invention.

Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### EXPERIMENTAL

Fabrication of Microfluidic Devices

Microfluidic masks were first designed using AutoCAD, and the desired device geometry printed as a transparent blank onto an opaque thin film (Micro Lithography Services Ltd). A layer of SU-8 photoresist (3 mL, MicroChemCorp) was spin-coated at 3000 rpm onto a silicon wafer (3 inch diameter, MicroChemicals) and baked at 96° C. for 12 minutes. The photolithographic mask with the desired device geometry was then placed on top of the coated silicon wafer, and clamped securely in position before being exposure to UV light to allow photochemical cross-linking of the irradiated portions of the photoresist. The silicon wafer was then post-baked for 5 minutes at 96° C. and subsequently developed in PGMEA. The wafer was then rinsed in isopropanol and dried with a nitrogen gun to yield a microfluidic master consisting of raised channels in the desired device geometry.

To produce microfluidic devices, the master mould was cast in PDMS (polydimethylsiloxane). A 1:10 ratio of curing agent to PDMS elastomer (Dow Corning) was thoroughly mixed and poured onto the master in a petri dish. The petri dish was then placed in a desiccator for 30 min in order to remove air bubbles from the PDMS, and subsequently baked at 65° C. for 120 min. The PDMS devices were then cut out with a scalpel and the inlets and outlets hole-punched with 0.75 mm diameter biopsy punchers (World Precision Instruments) and bonded to glass coverslips using an Electronic Diener Femto Plasma bonder (15 s, 40 mW).

Interferometric Scattering (iSCAT)) Experiments

Light from a 485 nm laser (PicoQuant, part number #LDh-d-c-485) was coupled to a microscope (Nikon TIE) via optical fibre and directed to the sample through a TIRF (total internal reflection fluorescence) objective (Nikon). The imaging was performed inside microfluidic chips fabricated as described above. The scattered light from the sample was collected through the same objective and focussed onto complementary metal-oxide semiconductor (CMOS) camera (Photometrics) by a tube lens after it had amplified with the reference light that had directly reflected from the glass coverslip.

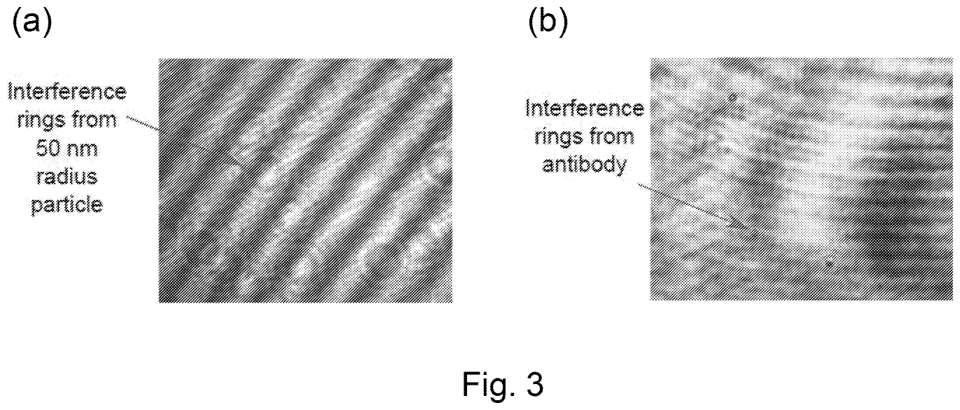

Interferometric scattering images were similarly acquired inside microfluidic devices using 25 um high microfluidic devices. The samples were excited by using a 485 nm laser. The scattered light from the sample interfered with the reflected light on the camera to yield an amplified signal. As for the TIRF images, the microfluidic channels of the devices were filled with samples to be imaged using a 1 mL plastic syringe connected to a polyethylene tubing through 27G needle. FIG. 3, Panel (a) shows the images of 10⁻⁶ v/v 50 nm radius fluorescent nanoparticles (ThermoFisher Scientific, Fluoro-Max Green, #G100) and panel (b) shows antibody molecules at a concentration of 0.1 mg/mL (ThermoFisher Scientific, goat anti-rabbit IgG conjugated to Alexa Fluor® 488). The images were taken using 1 ms exposure time.

Total Internal Reflection Fluorescence (TIRF) Experiments

Total internal reflection fluorescence images were acquired inside microfluidic devices fabricated to a height of 25 μm as described in above. The samples in the detection region of the devices were excited at critical angle using a 485 nm laser (PicoQuant, part number #LDh-d-c-485) obtained using a microscope objective (Nikon) of Numerical aperture 1.45.

The emitted light from the sample was collected through FITC filter cube (Nikon) and directed onto an Evolve Delta EMCCD camera (Photometrics).

The microfluidic channels of the devices were filled with samples to be imaged using a 1 mL plastic syringe (Fisher Scientific) connected to a polyethylene tubing (800/100/120, Smith's Medical) using 27G needle (Neolus Terumo).

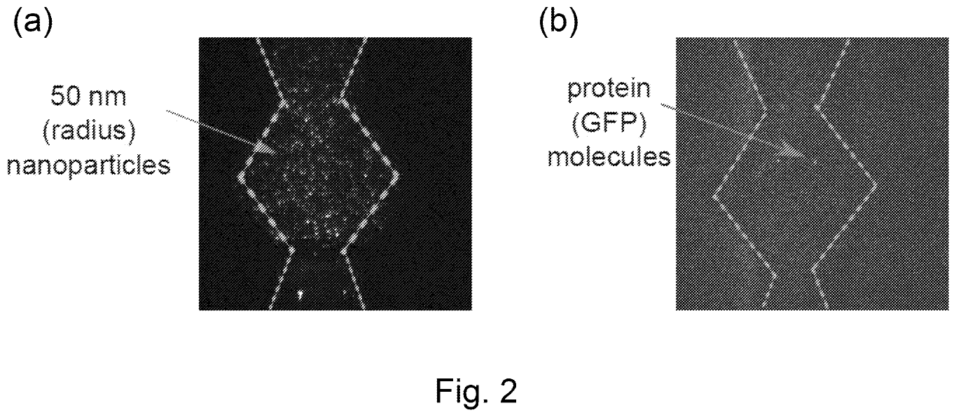

FIG. 2, Panel (a) shows the images of 10⁻⁶ v/v 50 nm radius fluorescent nanoparticles (ThermoFisher Scientific, Fluoro-Max Green, #G100) and panel (b) shows 100 nM green fluorescent protein (GFP) dissolved in 1× phosphate buffer saline using 400 ms exposure time for both samples.

Directing Module Experiments

The drawing was designed using Autocad (Autodesk) software. The design allows for the sample to become surrounded by co-flowing buffer from two sides. Several parallel detection areas (inset: DAᵢ₋₁, DAᵢ, DAᵢ₊₁) were designed to enable directing the sample sequentially into the images areas and for single molecule measurements to be performed in a multidimensional manner. The latter objective could be achieved by adjusting the ratio of the flow rates of the carrier medium from the two sides, Q_{cL} and Q_{cR} with the sample being injected at a flow rate of Q_{S}.

The microfluidic device was produced using the mask design shown in FIG. 4 to a height of 25 μm as described above.

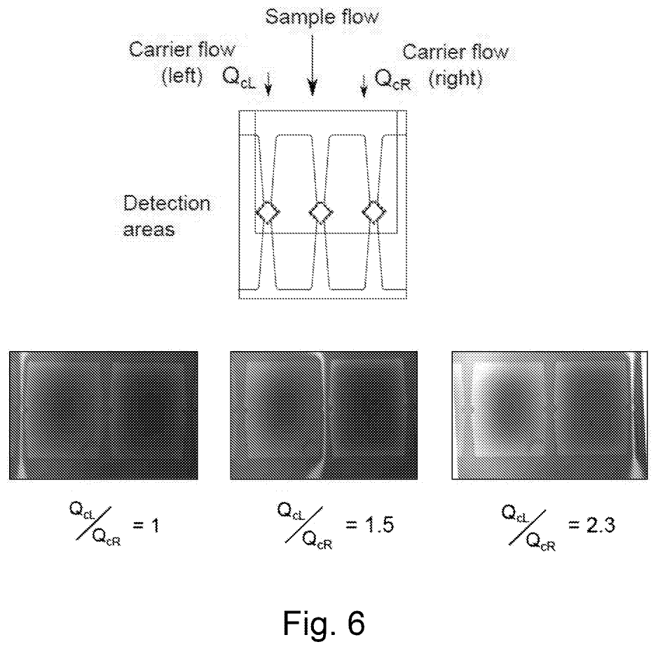

Fluorescent particles (ThermoFisher Scientific, Fluoro-Max Green, #G100) were injected through the sample inlet at a flow rate of Qₛ=25 μL h⁻¹ and mQ water from the buffer inlet at a flow rates of Q_{cR}=500 μL h⁻¹ and Q_{cR}=500 μL h⁻¹ using 1 mL glass syringes (Hamilton) connected to a polyethylene tubing through 27G needle as described previously. The flow rates of the fluids into the devices were controlled by syringe pumps (neMESYS, Cetoni). These flow conditions resulted in a narrow beam of the analyte particles at the centre of the device and the sample being directed into the middle detection area downstream. The flow rate ratio Q_{cR}/Q_{cL} was then increased to 600 μL h⁻¹/400 μL h⁻¹ =1.5 and, as a result, the particles were seen move towards the neighbouring detection area. Finally, the ratio was adjusted to 700 μL h⁻¹/300 μL h⁻¹=2.3, which resulted in the sample being deflected to the third detection area counting from the centre. FIG. 6 shows the results of these experiments.

The directing module can be used on its own to observe changes in the same sample over time (panel (a)). Alternatively, it can be used to follow the same sample under different environmental conditions that can be generated by mixing different components (panel (b)). Finally, the directing module can be used in combination with a separation unit to analyse different fractions eluting from a column separating the analytes either in the direction of the flow (panel (c)) or perpendicularly to it (panel (d)).

### REFERENCES

All documents mentioned in this specification are incorporated herein by reference in their entirety.
Herling et al., Applied Physics Letters 102, 2013, pp 184102-4.
Kamholz et al., Biophysical Journal 80(4), 2001, pp 1967-1972.
Lee et al., Science, 360(6387), 2018, pp 378-379. doi: 10.1126/science.aat5851
Tan et al., Biomicrofluidics 4, 2010, pp 032204.
Young et al., Science 360, 2018, pp 423-427
Piliarik et al., Nat. Commun, 2014, 5 (4495), doi:10.1038/ncomms5495
WO/2014/064438

### CLAUSES

Clause 1. A flow apparatus for detecting a component on a surface, comprising:
an inlet for receiving a solution of the components to be detected;
a detection module having a plurality of detection channels arranged in parallel in fluid connection with and downstream from the inlet, and in fluid connection with a downstream outlet
wherein a portion of the internal surface of each detection channel is a detection zone and the detection zone is configured to adhere to the component to be detected, such that the component is immobilised in the detection zone; and
a detector for detecting a component in the detection zone of each of the plurality of detection channels.

Clause 2. The flow apparatus of clause 1 wherein the detection zone is configured to adhere to the component to be detected by ionic interactions, covalent bonding or non-covalent interactions

Clause 3. The flow apparatus of clause 1 or clause 2 wherein each detection channel has a height of 500 μm or less.

Clause 4. The flow apparatus of any one of clauses 1 to 3 where each detection channel has a width of 100 μm or less.

Clause 5. The flow apparatus of clause 4 wherein each detection channel has a height of 100 μm or less.

Clause 6. The flow apparatus of any one of clauses 1 to 5 further comprising a director for directing flow from the inlet to individual detection channels of the plurality of detection channels.

Clause 7. A flow apparatus for detecting a component on a surface, comprising:
an inlet for receiving a solution of the components to be detected;
a detection chamber in fluid connection with and downstream from the inlet, and in fluid connection with a downstream outlet,
wherein the internal surface of the detection chamber comprises a plurality of detection zones and the detection zones are configured to adhere to the component to be detected such that the component is immobilised in the detection zones;
a detector for detecting components immobilised on each of the detection zones; and
a director for directing the flow of the solution of the components to each of the detection zones in sequence.

Clause 8. The flow apparatus of clause 7 wherein each of the plurality of detection zones has a width of from 20 μm to 150 μm as measured in the direction from a side wall of the detection chamber to an opposing side wall of the detection chamber.

Clause 9. The flow apparatus of any one of clauses 6 to 8 wherein the director is provided by electroosmotic force changes, pressure changes or flow rate changes.

Clause 10. The flow apparatus of clause 9 wherein the director is provided by flow rates.

Clause 11. The flow rate apparatus of clause 10 wherein the director comprises two directing inlets and the two directing inlets are positioned on opposite sides of the inlet and each of the two directing inlets is configured to provide variable flow rates.

Clause 12. The flow apparatus of any one of clause 1 to 11 wherein the detector is an optical detector.

Clause 13. The flow apparatus of clause 10 wherein the optical detector detects components by interferometric scattering microscopy or total internal reflection fluorescence microscopy.

Clause 14. The flow apparatus of any one of clauses 1 to 11 further having a treatment device in fluid connection with and upstream from the inlet.

Clause 15. The flow apparatus of clause 14 wherein the treatment device is a separation device.

Clause 16. The flow apparatus of clause 15 wherein the separation device is a batch separation device, such as a capillary electrophoresis device.

Clause 17. The flow apparatus of clause 15 wherein the separation device is a continuous separation device, such as a diffusion separation device or an electrophoresis separation device.

Clause 18. The flow apparatus of clause 14 wherein the treatment device is for adjustment of the pH and/or salt content of the solution.

Clause 19. The flow apparatus of any one of clauses 1 to 18 wherein the apparatus is adapted for detecting nanoparticles, protein molecules, colloids, complexes, oligomers, antibodies, nucleotides, biomolecules or biomolecular complexes.

Clause 20. Use of the flow apparatus of any one of clauses 1 to 19 to detect a component.

Clause 21. A method of detecting a component on a surface using a flow apparatus of any one of clauses 1 to 19, comprising providing a solution of the components to the inlet of the flow apparatus, establishing a flow of the solution containing the components through the inlet to the detection module or detection chamber, permitting the immobilisation of the component in the detection zone for detection by the detector and detecting the component using the detector.

1. A flow apparatus for detecting a component on a surface, comprising:
an inlet for receiving a solution of the components to be detected;
a detection chamber in fluid connection with and downstream from the inlet, and in fluid connection with a downstream outlet,
wherein the internal surface of the detection chamber comprises a plurality of detection zones and the detection zones are configured to adhere to the component to be detected such that the component is immobilised in the detection zones;
a detector for detecting components immobilised on each of the detection zones; and
a director for directing the flow of the solution of the components to each of the detection zones in sequence, wherein the director is provided by flow rates.

2. The flow apparatus of claim 1 wherein each of the plurality of detection zones has a width of from 20 μm to 150 μm as measured in the direction from a side wall of the detection chamber to an opposing side wall of the detection chamber.

3. The flow apparatus of claim 1, wherein the director is provided by electroosmotic force changes.

4. The flow apparatus of claim 1, wherein the director is provided by pressure changes.

5. The flow apparatus of claim 1, wherein the director is provided by flow rate changes.

6. The flow rate apparatus of claim 1, wherein the director comprises two directing inlets and the two directing inlets are positioned on opposite sides of the inlet and each of the two directing inlets is configured to provide variable flow rates.

7. The flow apparatus of claim 1, wherein the detector is an optical detector.

8. The flow apparatus claim 1, wherein the optical detector detects components by interferometric scattering microscopy or total internal reflection fluorescence microscopy.

9. The flow apparatus claim 1, further having a treatment device in fluid connection with and upstream from the inlet.

10. The flow apparatus of claim 9, wherein the treatment device is a separation device.

11. The flow apparatus of claim 10, wherein the separation device is a batch separation device, such as a capillary electrophoresis device.

12. The flow apparatus of claim 10, wherein the separation device is a continuous separation device, such as a diffusion separation device or an electrophoresis separation device.

13. The flow apparatus of claim 9, wherein the treatment device is for adjustment of the pH and/or salt content of the solution.

14. The flow apparatus of claim 1, wherein the apparatus is adapted for detecting nanoparticles, protein molecules, colloids, complexes, oligomers, antibodies, nucleotides, biomolecules or biomolecular complexes.

15. Use of the flow apparatus of claim 1 to detect a component.

16. A method of detecting a component on a surface using a flow apparatus of claim 1, comprising providing a solution of the components to the inlet of the flow apparatus, establishing a flow of the solution containing the components through the inlet to the detection module or detection chamber, permitting the immobilisation of the component in the detection zone for detection by the detector and detecting the component using the detector.
